(19) United States
(12) Patent Application Publication
(10) Pub. No.: US 2025/0065523 A1
(43) Pub. Date: Feb. 27, 2025

(54) Cutting Device, Multifunction Machine Tool and Method for Producing a Cutting Device

(71) Applicant: Robert Bosch GmbH, Stuttgart (DE)

(72) Inventors: Rhea Fritsch, Solothurn (CH); Johannes Mueller, Zollikofen (CH)

(21) Appl. No.: 18/722,846

(22) PCT Filed: Dec. 19, 2022
(86) PCT No.: PCT/EP2022/086541

§ 371 Date: Jun. 21, 2024

(30) Foreign Application Priority Data
Dec. 30, 2021 (DE) 10 2021 215 103.5

(51) Int. Cl. B26D 1/30; B26D 1/00

(52) U.S. Cl. CPC B26D 1/30; B26D 1/0006; B26D 2001/006

(57) ABSTRACT

A cutting device for an oscillating multifunction machine tool includes at least one shearing unit with at least one base body, a cutting edge and a backing edge. The cutting edge and the backing edge bound a cutting opening for inserting a workpiece. The cutting device further includes a tool interface for attaching the shearing unit to a tool holder of the multifunction machine tool. The cutting edge and the backing edge are disposed rigidly relative to one another and an angular bisector of a cutting opening angle of the cutting opening is disposed in a plane perpendicular to an oscillation axis of the tool interface, at an angle between 70° and 110° to a radial axis of the tool interface, which is perpendicular to the oscillation axis and passes through an intersection point of the cutting edge and the backing edge.

### PRIOR ART

A cutting device has previously been proposed, in particular an oscillating cutter, for an oscillating multifunction machine tool, having at least one shearing unit comprising at least one base body, a cutting edge, and a backing edge, wherein the cutting edge and the backing edge bound a cutting opening for inserting a workpiece, in particular a sheet metal workpiece, and having a tool interface for attaching the shearing unit to a tool holder of a multifunction machine tool.

### DISCLOSURE OF THE INVENTION

The invention relates to a cutting device, in particular an oscillating cutter, for an oscillating multifunction machine tool, having at least one shearing unit comprising at least one base body, a cutting edge, and a backing edge, wherein the cutting edge and the backing edge bound a cutting opening for inserting a workpiece, in particular a sheet metal workpiece, and having a tool interface for attaching the shearing unit to a tool holder of a multifunction machine tool.

It is proposed that the cutting edge and the backing edge are disposed rigidly relative to one another and that an angular bisector of a cutting opening angle of the cutting opening is disposed in a plane perpendicular to an oscillation axis of the tool interface, at an angle between 70° and 110° to a radial axis of the tool interface, which is perpendicular to the oscillation axis and runs through an intersection point of the cutting edge and the backing edge, and in a plane which is perpendicular to the oscillation axis.

Preferably, the cutting device is provided for cutting, particularly for shearing, the inserted workpiece, in particular a workpiece present at least partially in the cutting opening, by means of an oscillating movement of the multifunction machine tool. Preferably, the oscillating movement is transmitted from the tool holder to the shearing unit via the tool interface. Preferably, the base body is particularly at least substantially entirely made of metal, in particular carbide. The shearing unit is preferably particularly substantially entirely made of a metal, in particular carbide. Optionally, the shearing unit comprises a coating applied to the cutting edge and/or the backing edge. In particular, it should be understood that an object “substantially entirely made of a material” means that the object is at least 60% made of the material, preferably more than 70%, particularly preferably more than 80%, optionally more than 90%, with respect to a total volume of the object. Preferably, the shearing unit is formed in one piece. The term “in one piece” is in particular understood to mean shaped in one piece. Preferably, said one piece is produced from a single blank, a mass, and/or a casting, particularly preferably in an injection-molding method, in particular a single- and/or multi-component injection-molding method.

Preferably, the cutting edge and the backing edge are each formed from cutting edges of a component, in particular of the base body and/or of an additional blade. Preferably, an edge of the base body and/or of the blade forms the cutting edge. The backing edge is preferably formed from an edge of the base body. In particular, the fact that the cutting edge and the backing edge are “rigidly disposed relative to one another” should be understood to mean that the cutting edges have a fixed position relative to one another. Preferably, the components forming the cutting edges are fixedly disposed relative to each other, in particular connected to each other. Preferably, the fixed connection is configured as a positive, frictional, and/or material connection. A positive connection can be configured as a rivet connection, for example. However, a different positive connection, for example a pin connection, which appears to be useful to the person skilled in the art, is also conceivable. Alternatively, it would be conceivable for the components to be connected by means of a screw connection. The material connection is preferably implemented as a projection weld connection. However, a different material connection, for example an adhesive connection, which appears to be useful to the person skilled in the art, is also conceivable. It is conceivable that the cutting edge and the backing edge are produced integrally, in particular as one piece, from a blank of the base body by means of a punching method, forming method, casting process, and/or injection molding process. Other methods for producing cutting edges that appear to be useful to a person skilled in the art are also conceivable, for example further separation methods. Preferably, the shearing unit comprises at least the one intersection point between the cutting edge and the backing edge. In particular, an “intersection point” should be understood to mean an intersection point of the cutting edge and the backing edge, in particular on the cutting edge and/or the backing edge, when viewed in two dimensions perpendicular to a main extension plane of the base body. In particular, it is conceivable that the cutting edge and the backing edge do not have a concrete intersection point due to manufacture, but rather run skew to one another at a slight distance, wherein the intersection between the cutting edge and the backing edge is to be understood in particular as a point on the cutting edge or the backing edge at which a distance between the cutting edge and the backing edge is minimal. Preferably, the vertex of the cutting opening angle is disposed at the one intersection. Preferably, the oscillation axis of the tool interface, in an assembled state of the cutting device, is identical to the multifunction machine tool oscillation axis. In particular, a “cutting opening angle” is to be understood as an angle, as viewed in two dimensions in the main extension plane of the base body, enclosed by the cutting edge and/or a tangent of the cutting edge at the intersection point and the backing edge and/or a tangent of the backing edge at the intersection point. Preferably, the angle between the angular bisector of the cutting opening angle and the radial axis is between 70° and 110°, preferably between 80° and 100°, and more preferably between 85° and 95°. The base body is preferably flat in design. Preferably, a maximum material thickness of the base body is a maximum of 3 mm, preferably a maximum of 2 mm, and more preferably a maximum of 1 mm. Preferably, a distance between the intersection point and the oscillation axis is a maximum of 70 mm, preferably a maximum of 65 mm, and more preferably a maximum of 60 mm.

By means the embodiment of the cutting device according to the invention, an advantageously easily manufacturable, advantageously cost-efficient, and/or advantageously mechanically strong cutting device can be provided. In particular, a sheet metal cutting device can be advantageously provided for a multifunction machine tool, in particular for a machine tool having an oscillating circular motion as a tool drive. In particular, an advantageously low-vibration shear operation of the cutting device can be provided.

It is further suggested that the shearing unit comprises at least one blade, which forms at least the cutting edge, and is disposed on a lateral surface of the base body substantially perpendicular to the oscillation axis. Preferably, the blade is disposed on a lateral surface of the base body extending substantially parallel to a main extension plane of the base body. The lateral surface is in particular formed by a main surface, which in particular forms at least 20%, preferably at least 30%, of an outer surface of the base body. Preferably, in a mounted state of the cutting device on the multifunction machine tool, the lateral surface is a side of the base body facing toward the multifunction machine tool. The expression “substantially perpendicular” is intended in particular to define an orientation of a direction relative to a reference direction, wherein the direction and the reference direction, in particular viewed in a projection plane, enclose an angle of 90° and the angle has a maximum deviation of in particular less than 8°, advantageously less than 5° and particularly advantageously less than 2°. Preferably, the blade is disposed at an end region facing away from the workpiece interface, in particular the engagement region of the base body. Preferably, the end region extends over the entire transverse extent of the base body. Preferably, the end region extends from a side of the base body facing away from the workpiece interface in a longitudinal direction of the base body to a base body center having a maximum extent of 50%, preferably a maximum of 30%, and more preferably a maximum of 20% of the total longitudinal extent of the base body. A maximum material thickness of the blade is preferably less than the maximum material thickness of the base body. Preferably, the maximum material thickness of the blade is a maximum of 2.5 mm, preferably a maximum of 1.5 mm, and more preferably a maximum of 0.8 mm. By means of the embodiment of the cutting device according to the invention, an advantageously precise and low-vibration shear can be ensured. It is conceivable that the base body and/or the blade may have at least one tooth pattern on the sides thereof facing away from the tool interface. Preferably, the tooth pattern is provided to enable a start of the shear cut away from an edge of the workpiece, in particular of the sheet metal. A shearing unit having advantageously few manufacturing steps and advantageously few components can be provided. A cutting device having high flexibility with respect to the starting cut position can be advantageously provided.

Furthermore, it is proposed that the blade forms at least one further cutting edge and the base body forms at least one further backing edge, wherein the further cutting edge and the further backing edge bound a further cutting opening, and a further angular bisector of the further cutting opening is disposed in a plane perpendicular to the oscillation axis of the tool interface at an angle between 70° and 110° to the radial axis of the tool interface, which is perpendicular to the oscillation axis and runs through the intersection of the cutting edge and the backing edge, and in a plane perpendicular to the oscillation axis.

Preferably, the base body bounds a recess at least partially bounded by the backing edge and the further backing edge. Preferably, the recess opens in a shear direction of the cutting device. Preferably, the blade is disposed in said recess between the backing edge and the further backing edge, in a viewing direction perpendicular to the main extension plane of the base body. Preferably, the blade forms the cutting edge on a side facing the backing edge. Preferably, the blade forms the further cutting edge on a side facing the further backing edge. Preferably, the further cutting opening has a further cutting opening angle. The further cutting opening angle is preferably different from the cutting opening angle of the cutting opening. Preferably, the further cutting opening is disposed after the cutting opening when viewed in a direction from the tool interface towards the cutting opening. Preferably, the further cutting opening angle of the further cutting opening is smaller than the cutting opening angle of the cutting opening. By means of the embodiment according to the invention, a cutting device having a high flexibility with respect to the application of the cutting device for different sheet materials and thicknesses can advantageously be achieved. An advantageously high case of use can be achieved, in particular due to advantageously little vibration during operation.

It is further suggested that the shearing unit comprises at least one further blade, which is particularly identical to the blade and disposed on a further lateral surface of the base body facing away from the lateral surface, wherein the blade and the further blade are disposed congruent to each other when viewed perpendicular to a main extension plane of the base body. Preferably, the blade and the further blade are disposed such that the blade and the further blade and the shearing unit bound the cutting opening and/or the further cutting opening. By means of the embodiment of the cutting device according to the invention, two sides of a machined sheet can be advantageously produced, in particular free of burrs, by means of a single shearing.

Furthermore, it is proposed that the base body comprises at least one chamfered edge disposed on a side of the base body facing away from the blade and running parallel to the backing edge and/or to the further backing edge. Preferably, the chamfered edge and the backing edge and/or the further backing edge are disposed on a common side of the base body. Preferably, a chamfer of the chamfered edge of the base body is formed as a 45° chamfer having a width of between 1.5 mm and 0.1 mm, preferably between 1 mm and 0.3 mm, and more preferably of at least approximately 0.55 mm. By means of the embodiment of the cutting device according to the invention, an advantageously high ease of use can be achieved. An advantageously high cutting quality may be achieved by means of the cutting device.

It is further proposed that the blade and/or the further blade comprise at least one chamfered edge disposed on a side of the blade and/or of the further blade facing away from the base body and running parallel to the cutting edge and/or to the further cutting edge. Preferably, the chamfered edge of the blade and/or of the further blade is/are disposed on a common side of the blade having the cutting edge and/or the further cutting edge. Preferably, the chamfered edge is disposed directly adjacent to an edge of the cutting edge and/or of the further cutting edge. Preferably, a chamfer of the chamfered edge/s of the blade is formed as a 45° chamfer having a width of between 1.5 mm and 0.1 mm, preferably between 1 mm and 0.3 mm, and more preferably of at least approximately 0.55 mm. By means of the embodiment of the cutting device according to the invention, an advantageously high ease of use can be achieved. An advantageously high cutting quality can be achieved by means of the cutting device.

Furthermore, it is proposed that the base body comprises at least one carbide insert, which forms at least the cutting edge and/or the backing edge. Preferably, the carbide insert forms the further cutting edge and/or the further backing edge. By means of the embodiment according to the invention, an advantageously high service life of the cutting device can be achieved. An advantageously high cutting quality can be achieved by means of the cutting device.

Furthermore, it is proposed that the tool interface and the base body of the shearing unit are integrally connected to each other. By “integrally” it is intended to be understood in particular connected at least in a material manner, for example by an adhesive process, an injection process, and/or a welding process, in particular a projection welding process. It is also conceivable that the tool interface is integrally connected to the base body by means of a riveting and/or screwing process. Furthermore, it is conceivable that the tool interface and the base body are formed in one piece, such as by manufacture from a casting and/or by manufacture in a single-component or multi-component injection molding process, and advantageously from a single blank. Other connecting methods that appear useful to the person skilled in the art are also conceivable. By means of the embodiment according to the invention, an advantageously easy to produce sawing tool having an advantageously long service life can be provided.

Furthermore, it is proposed that the base body, the blade, and/or the further blade are integrally connected to one another. By means of the embodiment according to the invention, an advantageously easy to produce sawing tool having an advantageously long service life can be provided.

Further, a multifunction machine tool having at least one cutting device according to the invention is proposed. For example, the multi-function tool is an oscillating hand tool machine. In particular, the multifunction machine tool comprises at least one tool holder for coupling to a tool, in particular the tool interface of the cutting device. By means of the embodiment according to the invention, an advantageously easy to manufacture multifunction machine tool having a shear function can be produced.

Furthermore, a method is proposed for producing a cutting device according to the invention and/or a multifunction machine tool according to the invention. Preferably, in at least one method step, a cutting opening is produced by means of a forming and/or by means of a material connection. Other method steps that appear to be useful to a person skilled in the art for producing the cutting opening are also conceivable, for example a punching process. Preferably, the cutting opening is bounded by a cutting edge and a backing edge of the cutting device. In at least one method step, the cutting opening is preferably manufactured such that the cutting edge and the backing edge are rigidly disposed relative to one another and that an angular bisector of a cutting opening angle of the cutting opening, in a plane perpendicular to an oscillation axis of a tool interface of the cutting device, is disposed at an angle between 70° and 110° to a radial axis of the tool interface, which is perpendicular to the oscillation axis and passes through an intersection point of the cutting edge and the backing edge, and in a plane perpendicular to the oscillation axis. By means of the method according to the invention, a cutting device/a multifunction machine tool can be produced by means of advantageously few method steps.

Furthermore, it is proposed that a shearing unit of the cutting device is made from a blank, wherein in at least one method step the shearing unit is formed such that main extension planes of a blade and a base body of the shearing unit are disposed parallel to one another. Preferably, the base body comprises at least two regions, wherein in particular a forming axis is disposed between the two regions. A first of the two regions preferably forms the blade having the cutting edge and/or the further cutting edge, while a second of the two regions is preferably formed by a part of the base body, which forms the backing edge and/or the further backing edge. Preferably, in at least one method step, the first region of the still un-formed base body is formed about the forming axis, in particular by 180°, so that the blade abuts a lateral surface of the base body. Preferably, in at least one method step, the first region is formed by means of a free bending process. However, a different method appearing to be useful to a person skilled in the art is also conceivable, in particular a bending method, such as a die bending method and/or a buckling method. Preferably, the first region is formed about the forming axis such that the first region and the second region, in particular the blade and the base body, in particular the cutting edge and the backing edge and/or the further cutting edge and the further backing edge, bound a cutting opening. By means of the method according to the invention, a cutting device/multifunction machine tool may advantageously be produced without a separation method and/or a material bonding method.

Furthermore, it is proposed that the shearing unit is produced by at least one material connection between at least one blade and a base body of the shearing unit. By means of the method according to the invention, a cutting device/multifunction machine tool can be advantageously produced without a forming process.

The cutting device according to the invention, the multifunction machine tool according to the invention, and/or the method according to the invention should not be limited to the application and embodiment described above. In particular, the cutting device according to the invention, the multifunction machine tool according to the invention, and/or the method according to the invention may have a quantity of individual elements, components, units, and method steps that differs from a quantity specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. Fifteen exemplary embodiments of the invention are shown in the drawing. The drawings, the description, and the claims contain numerous features in combination. A person skilled in the art will appropriately also consider the features individually and combine them into additional advantageous combinations.

Shown are:

FIG. 1 a multifunction machine tool according to the invention having a cutting device according to the invention in a schematic illustration,

FIG. 2 a schematic illustration of the cutting device according to the invention having a tool interface and a shearing unit,

FIG. 3 a schematic illustration of an alternative cutting device according to the invention having a tool interface and a shearing unit,

FIG. 4 a schematic illustration of an alternative cutting device according to the invention having a tool interface and a shearing unit having a blade,

FIG. 5 a schematic illustration of an alternative cutting device according to the invention with a tool interface and a shearing unit having a blade,

FIG. 6 a schematic illustration of an alternative cutting device according to the invention having a tool interface and a shearing unit having a blade having a chamfered edge,

FIG. 7 a schematic illustration of an alternative cutting device according to the invention having a tool interface and a shearing unit having a blade,

FIG. 8 a schematic illustration of an alternative cutting device according to the invention having a tool interface, a shearing unit having a blade, and two cutting openings,

FIG. 9 a schematic illustration of an alternative cutting device according to the invention having a tool interface and a shearing unit having a blade having a chamfered edge,

FIG. 10 a schematic illustration of an alternative cutting device according to the invention having a tool interface, a shearing unit having a blade, and a base body having a chamfered edge,

FIG. 11 a schematic illustration of an alternative cutting device according to the invention having a tool interface and a shearing unit having a blade,

FIG. 12 a schematic illustration of an alternative cutting device according to the invention having a tool interface and a shearing unit having a blade,

FIG. 13 a schematic illustration of an alternative cutting device according to the invention having a shearing unit having a blade,

FIG. 14 a schematic illustration of an alternative cutting device according to the invention having a base body,

FIG. 15 a schematic illustration of an alternative cutting device according to the invention having a base body,

FIG. 16 a schematic illustration of an alternative cutting device according to the invention having a base body, and

FIG. 17 a schematic illustration of an alternative cutting device according to the invention having a tool interface, a shearing unit having two blades and having two cutting openings.

### DESCRIPTION OF THE EXEMPLARY EMBODIMENTS

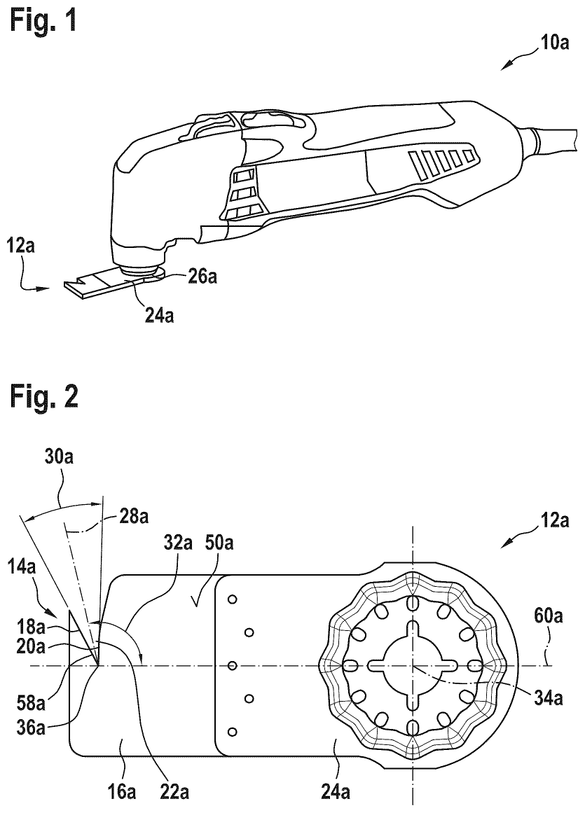

FIG. 1 shows a multifunction machine tool 10a configured to drive a cutting device 12a by means of an oscillating movement. The multifunction machine tool 10a comprises a cutting device 12a according to the invention. The multifunction machine tool 10a is configured, for example, as an oscillating hand machine tool. The multifunction machine tool 10a has a tool holder 26a for coupling to a tool, in particular a tool interface 24a of the cutting device 12a.

The cutting device 12a comprises a shearing unit 14a. The shearing unit 14a comprises a base body 16a, which comprises a cutting edge 18a and a backing edge 20a. The cutting edge 18a and the backing edge 20a bound a cutting opening 22a for inserting a workpiece, in particular a sheet metal workpiece. The cutting device 12a comprises the tool interface 24a for fastening the shearing unit 14a to the tool holder 26a of the multifunction machine tool 10a. The cutting edge 18a and the backing edge 20a are disposed rigidly relative to each other. An angular bisector 28a of a cutting opening angle 30a of the cutting opening 22a is disposed in a plane perpendicular to an oscillation axis 34a of the tool interface 24a, at an angle 32a between 70° and 110° to a radial axis 60a of the tool interface 24a, which is perpendicular to the oscillation axis 34a and passes through an intersection point 36a of the cutting edge 18a and the backing edge 20a, and in a plane perpendicular to the oscillation axis 34a (FIG. 2).

The base body 16a is made of metal, in particular carbide. The shearing unit 14a is particularly substantially entirely made of a metal, in particular carbide. The shearing unit 14a is formed in one piece. The shearing unit 14a comprises the one intersection point 36a between the cutting edge 18a and the backing edge 20a. The vertex of the cutting opening angle 30a is disposed at the intersection point 36a. The oscillation axis 34a of the tool interface 24a, in an assembled state of the cutting device 12a, is identical to the multifunction machine tool oscillation axis. The angle 32a between the angular bisector 28a of the cutting opening angle 30a and the radial axis 60a is between 70° and 110°, preferably between 80° and 100°, and more preferably between 859 and 95°. The base body 16a is flat in design. The maximum material thickness of the base body 16a is 1 mm. The tool interface 24a and the base body 16a of the shearing unit 14a are integrally connected to each other. The tool interface 24a and the base body 16a are connected to each other by means of a welded connection. The welded connection is made by means of a projection welding process. It is also conceivable that the connection is produced integrally by means of a different joining process that appears to be useful to a person skilled in the art. For example, a further welding process, an adhesive process, and/or a riveting and/or screwing process. The cutting edge 18a extends at a 65° angle 32a to a main direction of extent of the base body 16a in a plane perpendicular to the oscillation axis 34a. The backing edge 20a runs in a region forming a leg of the cutting opening angle 30a, in a plane perpendicular to the oscillation axis 34a, perpendicular to the main direction of extent of the base body 16a. The term “main direction of extent” of an object is in particular understood to mean a direction extending parallel to a longest edge of a smallest geometrical cuboid just completely enclosing the object (FIG. 2).

In the following, a method is described for producing a cutting device 12a according to the invention and/or a multifunction machine tool 10a according to the invention. In a method step, a cutting opening 22a is produced by means of a forming and/or by means of a material connection. Other method steps that appear to be useful to a person skilled in the art for producing the cutting opening 22a are also conceivable, for example a punching process. In a method step, the cutting opening 22a is preferably produced such that the cutting edge 18a and the backing edge 20a are disposed rigidly relative to one another and that an angular bisector 28a of a cutting opening angle 30a of the cutting opening 22a is disposed in a plane perpendicular to an oscillation axis 34a of a tool interface 24a of the cutting device 12a, at an angle 32a between 70° and 110° to a radial axis 60a of tool interface 24a, which is perpendicular to the oscillation axis 34a and passes through an intersection point 36a of the cutting edge 18a and the backing edge 20a, and in a plane perpendicular to the oscillation axis 34a (FIG. 2).

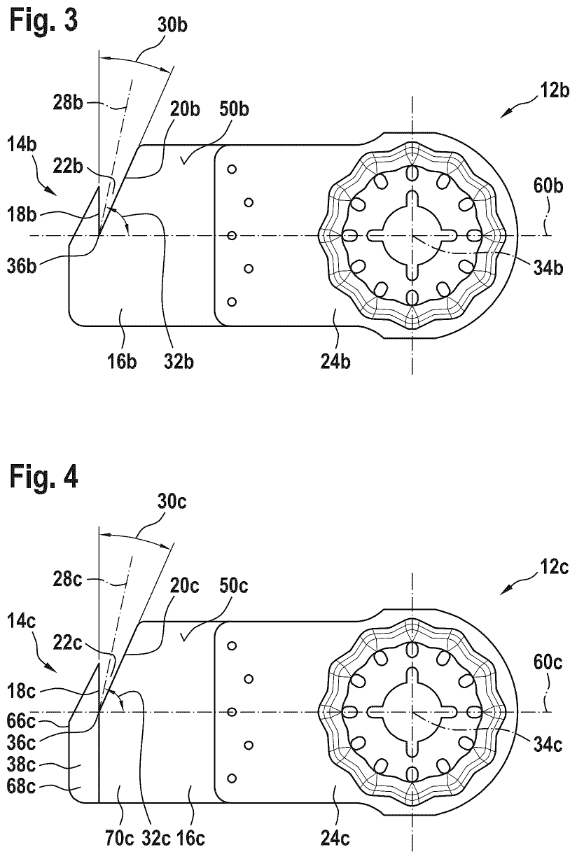

FIGS. 3 to 17 show 14 alternative embodiment examples of the invention. The following description and the drawings are limited substantially to the differences between the exemplary embodiments, wherein, with respect to identically named components, in particular with respect to components having identical reference signs, reference can in principle also be made to the drawings and/or the description of the other exemplary embodiments, in particular of FIGS. 1 and 2. To distinguish between the exemplary embodiments, the letter a has been placed after the reference signs of the exemplary embodiment in FIGS. 1 and 2. In the exemplary embodiments of FIGS. 3 through 17, the letter a is replaced by letters b to o.

FIG. 3 shows a cutting device 12b. The cutting device 12b comprises a shearing unit 14b. The shearing unit 14b comprises a base body 16b, which comprises a cutting edge 18b and a backing edge 20b. The cutting edge 18b and the backing edge 20b bound a cutting opening 22b for inserting a workpiece, in particular a sheet metal workpiece. The cutting device 12b comprises a tool interface 24b for attaching the shearing unit 14b to a tool holder 26b of a multifunction machine tool 10b. The cutting edge 18b and the backing edge 20b are disposed rigidly relative to each other. An angular bisector 28b of a cutting opening angle 30b of the cutting opening 22b is disposed in a plane perpendicular to an oscillation axis 34b of the tool interface 24b, at an angle 32b between 70° and 110° to a radial axis 60b of the tool interface 24b, which is perpendicular to the oscillation axis 34b and passes through an intersection point 36b of the cutting edge 18b and the backing edge 20b, and in a plane perpendicular to the oscillation axis 34b. The base body 16b comprises a carbide insert 58b, which forms the cutting edge 18b and the backing edge 20b. The cutting edge 18b runs perpendicular to a main direction of extent of the base body 16b in a plane perpendicular to the oscillation axis 34b. The backing edge 20b runs at a 66° angle to the main direction of extent of the base body 16b in a plane perpendicular to the oscillation axis 34b (FIG. 3).

FIG. 4 shows a cutting device 12c. The cutting device 12c comprises a shearing unit 14c. The shearing unit 14c comprises a base body 16c, which comprises a cutting edge 18c and a backing edge 20c. The cutting edge 18c and the backing edge 20c bound a cutting opening 22c for inserting a workpiece, in particular a sheet metal workpiece. The cutting device 12c comprises a tool interface 24c for attaching the shearing unit 14c to a tool holder 26c of a multifunction machine tool 10c. The cutting edge 18c and the backing edge 20c are disposed rigidly relative to one another. An angular bisector 28c of a cutting opening angle 30c of the cutting opening 22c is disposed in a plane perpendicular to an oscillation axis 34c of the tool interface 24c, at an angle 32c between 70° and 110° to a radial axis 60c of the tool interface 24c, which is perpendicular to the oscillation axis 34c and passes through an intersection point 36c of the cutting edge 18c and the backing edge 20c, and in a plane perpendicular to the oscillation axis 34c.

The shearing unit 14c comprises a blade 38c forming the cutting edge 18c. The blade 38c is disposed on a lateral surface 50c of the base body 16c running substantially perpendicular to the oscillation axis 34c. The blade 38c is disposed at an end region of the base body 16c facing away from the tool interface 24c. A maximum material thickness of the blade 38c is less than the maximum material thickness of the base body 16c. The maximum material thickness of the blade 38c is 0.8 mm. The blade 18c runs in a plane perpendicular to the oscillation axis 34c, perpendicular to a main direction of extent of the base body 16c. The backing edge 20c runs in a plane perpendicular to the oscillation axis 34c, at a 66° angle to the main direction of extent of the base body 16c. The base body 16c and the blade 38c are integrally connected to one another. The base body 16c and the blade 38c are connected to one another by means of a welded connection. The welded connection is made by means of a projection welding process. It is also conceivable that the connection is made integrally by means of a different joining process that appears to be useful to a person skilled in the art. For example, a further welding process, an adhesive process, and/or a riveting and/or screwing process (FIG. 4).

An alternative method for producing a cutting device 12c according to the invention and/or a multifunction machine tool 10c according to the invention is described below. In a method step, a shearing unit 14c of the cutting device 12c is made from a blank. In a method step, the shearing unit 14c is formed such that main extension planes of a blade 38c and a base body 16c of the shearing unit 14c are disposed parallel to one another. The base body 16c comprises two regions 68c, 70c. A forming axis 66c is disposed between the two regions 68c, 70c. A first of the two regions 68c forms the blade 38c having the cutting edge 18c. A second of the two regions 70c is formed by a part of the base body 16c which forms the backing edge 20c. In at least one method step, the first region 68c of the still unformed base body 16c is formed about the forming axis 66c, in particular by 180°, such that the blade 38c abuts a lateral surface 50c of the base body 16c. In at least one method step, the first region 68c is formed by means of a free-bending process. However, a different method appearing to be useful to a person skilled in the art is also conceivable, in particular a bending method, such as a die bending method and/or a buckling method. The first region 68c is deformed about the forming axis 66c such that the first region 68c and the second region 70c, in particular, the blade 38c and the base body 16c, in particular, the cutting edge 18c and the backing edge 20c bound the cutting opening 22c. In an alternative method, a shearing unit 14c is produced by at least one material connection between at least one blade 38c and a base body 16c of the shearing unit 14c. The material connection is produced, for example, in a method step by an adhesive process, an injection process, and/or a welding process, in particular a projection welding process. It is also conceivable that the blade 38c may be connected to the base body 16c by a riveting and/or screwing process (FIG. 4).

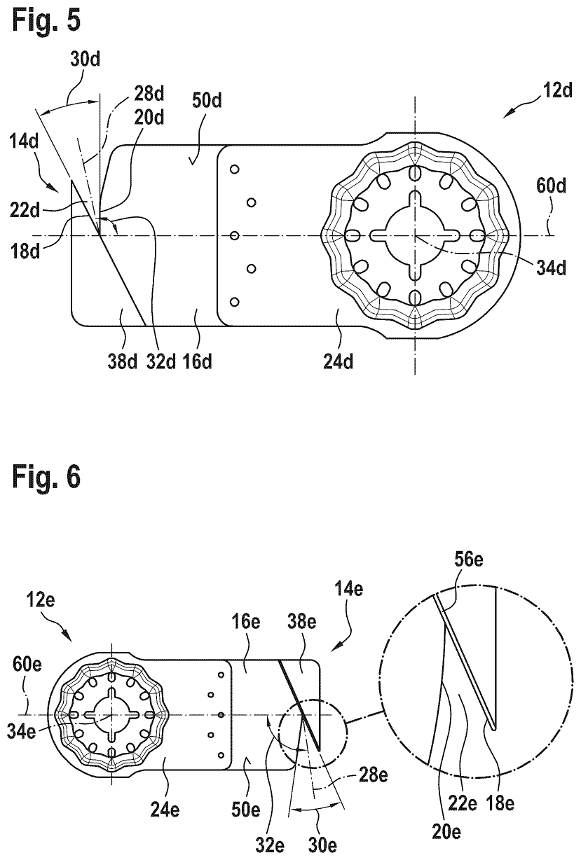

FIG. 5 shows a cutting device 12d. The cutting device 12d comprises a shearing unit 14d. The shearing unit 14d comprises a base body 16d, which comprises a cutting edge 18d and a backing edge 20d. The cutting edge 18d and the backing edge 20d bound a cutting opening 22d for inserting a workpiece, in particular a sheet metal workpiece. The cutting device 12d comprises a tool interface 24d for attaching the shearing unit 14d to a tool holder 26d of a multifunction machine tool 10d. The cutting edge 18d and the backing edge 20d are disposed rigidly relative to each other. An angular bisector 28d of a cutting opening angle 30d of the cutting opening 22d is disposed in a plane perpendicular to an oscillation axis 34d of the tool interface 24d, at an angle 32d between 70° and 110° to a radial axis 60d of the tool interface 24d, which is perpendicular to the oscillation axis 34d and passes through an intersection point 36d of the cutting edge 18d and the backing edge 20d, and in a plane which is perpendicular to the oscillation axis 34d.

The shearing unit 14d comprises a blade 38d forming the cutting edge 18d. The blade 38d is disposed on a lateral surface 50d of the base body 16d, which is substantially perpendicular to the oscillation axis 34d. The blade 38d is disposed at an end region of the base body 16d facing away from the tool interface 24d. A maximum material thickness of the blade 38d is less than the maximum material thickness of the base body 16d. The blade 38d has three sides in a longitudinal section, which enclose three corners. One of the three corners, which does not contact the cutting edge 18d, has a radius. The cutting edge 18d forms the longest of the three sides. The blade 18d faces the oscillation axis 34d. The cutting edge 18d extends at a 63° angle to a main direction of extent of the base body 16d in a plane perpendicular to the oscillation axis 34d. The backing edge 20d extends perpendicular to the main direction of extent of the base body 16d in a plane perpendicular to the oscillation axis 34d, in a region which extends a leg of the cutting opening angle 30d (FIG. 5).

FIG. 6 shows a cutting device 12e. The cutting device 12e comprises a shearing unit 14e. The shearing unit 14e comprises a base body 16e, which comprises a cutting edge 18e and a backing edge 20e. The cutting edge 18e and the backing edge 20e bound a cutting opening 22e for inserting a workpiece, in particular a sheet metal workpiece. The cutting device 12e comprises a tool interface 24e for fastening the shearing unit 14e to a tool holder 26e of a multifunction machine tool 10e. The cutting edge 18e and the backing edge 20e are disposed rigidly relative to each other. An angular bisector 28e of a cutting opening angle 30e of the cutting opening 22e is disposed at an angle 32e between 70° and 110° to a radial axis 60e of the tool interface 24e in a plane perpendicular to an oscillation axis 34e of the tool interface 24e, which is perpendicular to the oscillation axis 34e and passes through an intersection point 36e of the cutting edge 18e and the backing edge 20e, and in a plane which is perpendicular to the oscillation axis 34e.

The shearing unit 14e comprises a blade 38e forming the cutting edge 18e. The blade 38e is disposed on a lateral surface 50e of the base body 16e, which runs substantially perpendicular to the oscillation axis 34e. The blade 38e is disposed at an end region of the base body 16e facing away from the tool interface 24e. A maximum material thickness of the blade 38e is less than the maximum material thickness of the base body 16e. The blade 38e has three sides in a longitudinal section, which enclose three corners. One of the three corners, which does not contact the cutting edge 18e, has a radius. The cutting edge 18e forms the longest of the three sides. The blade 18e faces the oscillation axis 34e. The blade 38e has a chamfered edge 56e, which is disposed on a side of the blade 38e facing away from the base body 16e and runs parallel to the cutting edge 18e (FIG. 6).

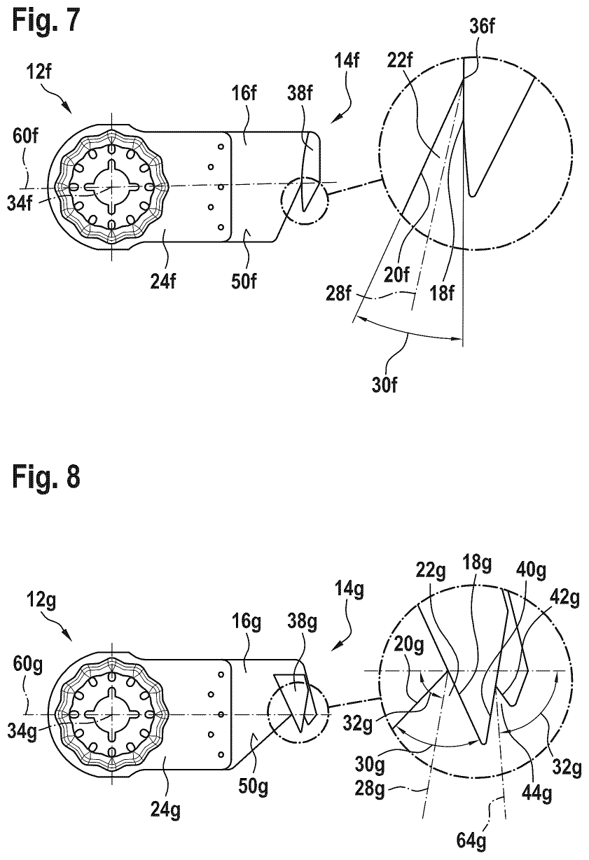

FIG. 7 shows a cutting device 12f. The cutting device 12f comprises a shearing unit 14f. The shearing unit 14f comprises a base body 16f, which comprises a cutting edge 18f and a backing edge 20f. The cutting edge 18f and the backing edge 20f bound a cutting opening 22f for inserting a workpiece, in particular a sheet metal workpiece. The cutting device 12f comprises a tool interface 24f for fastening the shearing unit 14f to a tool holder 26f of a multifunction machine tool 10f. The cutting edge 18f and the backing edge 20f are disposed rigidly relative to one another. An angular bisector 28f of a cutting opening angle 30f of the cutting opening 22f is disposed in a plane perpendicular to an oscillation axis 34f of the tool interface 24f, at an angle 32f between 70° and 110° to a radial axis 60f of the tool interface 24f, which is perpendicular to the oscillation axis 34f and passes through an intersection point 36f of the cutting edge 18f and the backing edge 20f, and in a plane perpendicular to the oscillation axis 34f.

The shearing unit 14f comprises a blade 38f forming the cutting edge 18f. The blade 38f is disposed on a lateral surface 50f of the base body 16f, which is substantially perpendicular to the oscillation axis 34f. The blade 38f is disposed at an end region of the base body 16f facing away from the tool interface 24f. A maximum material thickness of the blade 38f is less than the maximum material thickness of the base body 16f. The cutting edge 18f, which faces the oscillation axis 34f, has a radius (FIG. 7).

FIG. 8 shows a cutting device 12g. The cutting device 12g comprises a shearing unit 14g. The shearing unit 14g comprises a base body 16g, which comprises a cutting edge 18g and a backing edge 20g. The cutting edge 18g and the backing edge 20g bound a cutting opening 22g for inserting a workpiece, in particular a sheet metal workpiece. The cutting device 12g comprises a tool interface 24g for fastening the shearing unit 14g to a tool holder 26g of a multifunction machine tool 10g. The cutting edge 18g and the backing edge 20g are disposed rigidly relative to each other. An angular bisector 28g of a cutting opening angle 30g of the cutting opening 22g is disposed in a plane perpendicular to an oscillation axis 34g of the tool interface 24g, at an angle 32g between 70° and 110° to a radial axis 60g of the tool interface 24g, which is perpendicular to the oscillation axis 34g and passes through an intersection point 36g of the cutting edge 18g and the backing edge 20g, and in a plane which is perpendicular to the oscillation axis 34g.

The blade 38g forms a further cutting edge 40g. The base body 16g forms a further backing edge 42g. The further cutting edge 40g and the further backing edge 42g bound a further cutting opening 44g. A further angular bisector 64g of the further cutting opening 44g is disposed in a plane perpendicular to the oscillation axis 34g of the tool interface 24g, at an angle 32g between 70° and 110° to the radial axis 60g of the tool interface 24g, which is perpendicular to the oscillation axis 34g, and runs through the intersection point 36g of the cutting edge 18g and the backing edge 20g, and in a plane perpendicular to the oscillation axis 34g (FIG. 8).

The further cutting opening 44g has a further cutting opening angle. The further cutting opening angle is different from the cutting opening angle 30g of the cutting opening 22g. The further cutting opening 44g is disposed after the cutting opening 22g when viewed in a direction from the tool interface 24g towards the cutting opening 22g. The further cutting opening angle of the further cutting opening 44g is smaller than the cutting opening angle 30g of the cutting opening 22g. The cutting edge 18g runs at a 65° angle to a main direction of extent of the base body 16g in a plane perpendicular to the oscillation axis 34g. The backing edge 20g runs at a 45° angle to the main direction of extent of the base body 16g in a plane perpendicular to the oscillation axis 34g. The further cutting edge 40g runs parallel to the cutting edge 18g in a plane perpendicular to the oscillation axis 34g. The further backing edge 42g runs at an 80° angle to the main direction of extent of the basic body 16g in a plane perpendicular to the oscillation axis 34g (FIG. 8).

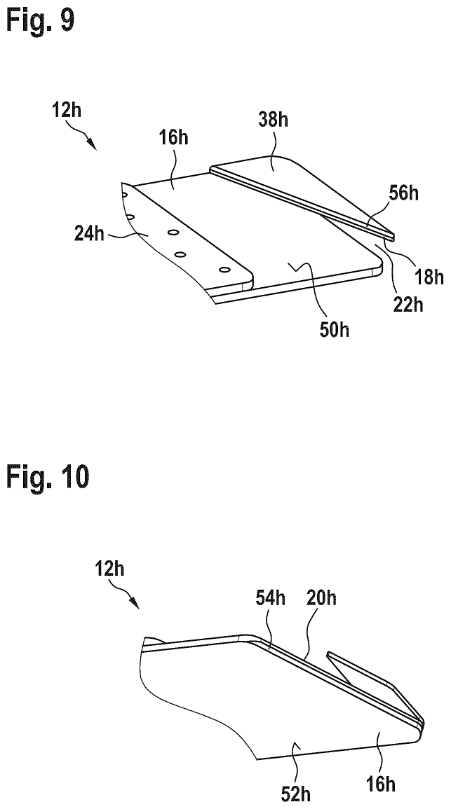

FIGS. 9 and 10 each show a cutting device 12h. The cutting device 12h comprises a shearing unit 14ₕ. The shearing unit 14h comprises a base body 16h, which comprises a cutting edge 18h and a backing edge 20h. The cutting edge 18h and the backing edge 20h bound a cutting opening 22h for inserting a workpiece, in particular a sheet metal workpiece. The cutting device 12h comprises a tool interface 24h for attaching the shearing unit 14h to a tool holder 26h of a multifunction machine tool 10h. The cutting edge 18h and the backing edge 20h are disposed rigidly relative to one another. An angular bisector 28h of a cutting opening angle 30h of the cutting opening 22h is disposed in a plane perpendicular to an oscillation axis 34h of the tool interface 24h, at an angle of 32h between 70° and 110° to a radial axis 60h of the tool interface 24h, which is perpendicular to the oscillation axis 34h and passes through an intersection point 36h of the cutting edge 18h and the backing edge 20h, and in a plane which is perpendicular to the oscillation axis 34h.

The base body 16h has at least one chamfered edge 54h, which is disposed on a side of the base body 16h facing away from the blade 38h and runs parallel to the backing edge 20h. The chamfered edge 54h and the backing edge 20h are disposed on a common side of the base body 16h. A chamfer of the chamfered edge 54h of the base body 16h is configured as a 45° chamfer having a width of 0.55 mm. However, other embodiments of the chamfer which appear to be useful to a person skilled in the art are also conceivable, for example 45°×1 mm or 45°×0.3 mm (FIG. 9). The blade 38h has a chamfered edge 56h, which is disposed on a side of the blade 38h facing away from the base body 16h and runs parallel to the cutting edge 18h. The chamfered edge 56h of the blade 38h is disposed on a common side of the blade 38h with the cutting edge 18h. Preferably, a chamfer of the chamfered edge 56h of the blade 38h is formed as a 45° chamfer having a width of 0.55 mm. However, other embodiments of the chamfer which appear to be useful to a person skilled in the art are also conceivable, for example 45°×1 mm or 45°×0.3 mm (FIG. 10).

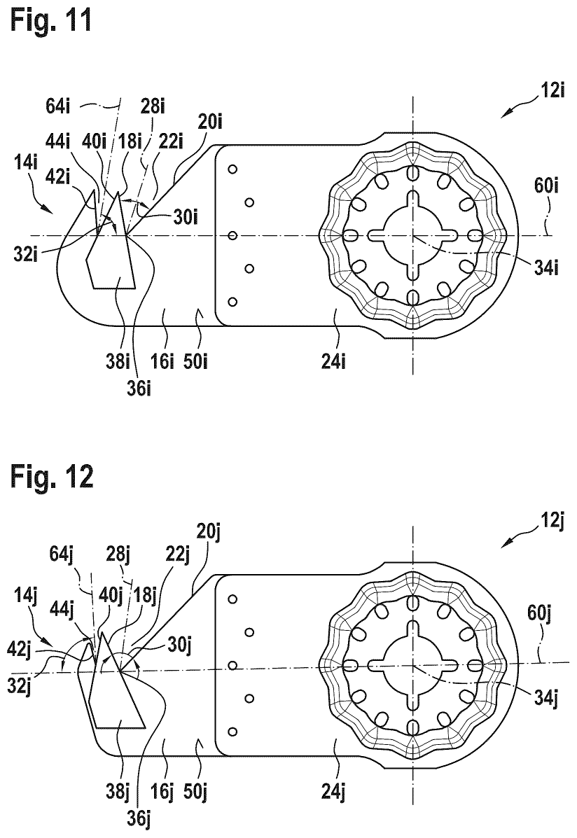

FIG. 11 shows a cutting device 12i. The cutting device 12i comprises a shearing unit 14. The shearing unit 14i comprises a base body 16i, which comprises a cutting edge 18i and a backing edge 20i. The cutting edge 18i and the backing edge 20i bound a cutting opening 22i for inserting a workpiece, in particular a sheet metal workpiece. The cutting device 12i comprises a tool interface 24i for fastening the shearing unit 14i to a tool holder 26i of a multifunction machine tool 10i. The cutting edge 18i and the backing edge 20i are disposed rigidly relative to one another. An angular bisector 28i of a cutting opening angle 30i of the cutting opening 22i is disposed in a plane perpendicular to an oscillation axis 34 of the tool interface 24i, at an angle 32i between 70° and 110° to a radial axis 60i of the tool interface 24i, which is perpendicular to the oscillation axis 34i and passes through an intersection point 36 of the cutting edge 18i and the backing edge 20i, and in a plane which is perpendicular to the oscillation axis 34i.

The blade 38i forms a further cutting edge 40i. The base body 16i forms a further backing edge 42i. The further cutting edge 40i and the further backing edge 42i bound a further cutting opening 44i. A further angular bisector 64i of the further cutting opening 44i is provided in a plane perpendicular to the oscillation axis 34i of the tool interface 24i, at an angle 32i between 70° and 110° to the radial axis 60i of the tool interface 24i, which is perpendicular to the oscillation axis 34i and runs through the intersection point 36i of the cutting edge 18i and the backing edge 20i, and in a plane perpendicular to the oscillation axis 34i (FIG. 11).

The further cutting opening 44i has a further cutting opening angle. The further cutting opening angle is different from the cutting opening angle 30i of the cutting opening 22i. The further cutting opening 44i is disposed after the cutting opening 22i when viewed in a direction from the tool interface 241 towards the cutting opening 22i. The further cutting opening angle of the further cutting opening 44i is smaller than the cutting opening angle 30i of the cutting opening 22i. The cutting edge 18i extends at a 80° angle to a main direction of extent of the base body 16i in a plane perpendicular to the oscillation axis 34i. The backing edge 20i is at a 51° angle to the main direction of extent of the base body 16i in a plane perpendicular to the oscillation axis 34i. The further cutting edge 40i is at a 66° angle to the main direction of extent of the base body 16i in a plane perpendicular to the oscillation axis 34i. The further backing edge 42i is at an 85° angle to the main direction of extent of the base body 16i, in a plane perpendicular to the oscillation axis 34i (FIG. 11).

FIG. 12 shows a cutting device 12i. The cutting device 12j comprises a shearing unit 14j. The shearing unit 14j comprises a base body 16j, which comprises a cutting edge 18j and a backing edge 20j. The cutting edge 18j and the backing edge 20j bound a cutting opening 22j for inserting a workpiece, in particular a sheet metal workpiece. The cutting device 12j comprises a tool interface 24j for attaching the shearing unit 14j to a tool holder of a multifunction machine tool 10j. The cutting edge 18j and the backing edge 20j are disposed rigidly relative to one another. An angular bisector 28j of a cutting opening angle 30j of the cutting opening 22j is disposed in a plane perpendicular to an oscillation axis 34j of the tool interface 24j, at an angle 32j between 70° and 110° to a radial axis 60j of the tool interface 24j, which is perpendicular to the oscillation axis 34j and passes through an intersection point 36j of the cutting edge 18j and the backing edge 20j, and in a plane which is perpendicular to the oscillation axis 34j.

The blade 38j forms a further cutting edge 40j. The base body 16j forms a further backing edge 42j. The further cutting edge 40j and the further backing edge 42j bound a further cutting opening 44j. A further angular bisector 64j of the further cutting opening 44j is disposed in a plane perpendicular to the oscillation axis 34j of the tool interface 24j, at an angle 32j between 70° and 110° to the radial axis 60j of the tool interface 24j, which is perpendicular to the oscillation axis 34j and which passes through the intersection point 36j of the cutting edge 18j and the backing edge 20j, and in a plane perpendicular to the oscillation axis 34j (FIG. 12).

The further cutting opening 44j has a further cutting opening angle. The further cutting opening angle is different from the cutting opening angle 30j of the cutting opening 22j. The further cutting opening 44j, when viewed in a direction from the tool interface 24j towards the cutting opening 22j, is disposed after the cutting opening 22j. The further cutting opening angle of the further cutting opening 44j is smaller than the cutting opening angle 30j of the cutting opening 22j. The cutting edge 18j is at a 65° angle to a main direction of extent of the base body 16j in a plane perpendicular to the oscillation axis 34j. The backing edge 20j is at a 46° angle to the main direction of extent of the base body 16j in a plane perpendicular to the oscillation axis 34j. The further cutting edge 40j is at a 80° angle to the main direction of extent of the base body 16j in a plane perpendicular to the oscillation axis 34j. The further backing edge 42j is at a 75° angle to the main direction of extent of the base body 16j in a plane perpendicular to the oscillation axis 34j (FIG. 12).

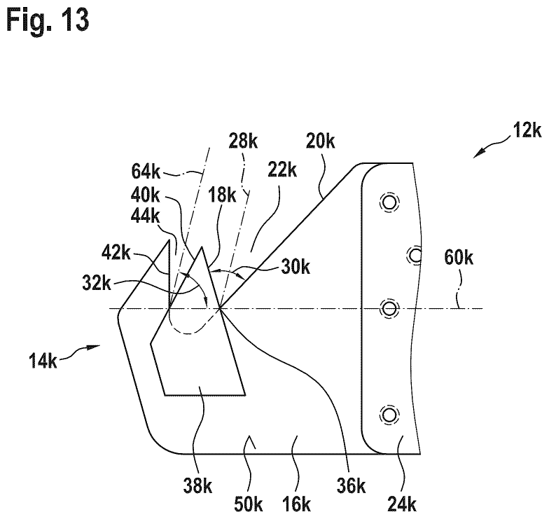

FIG. 13 shows a cutting device 12k. The cutting device 12k comprises a shearing unit 14k. The shearing unit 14k comprises a base body 16k, which comprises a cutting edge 18k and a backing edge 20k. The cutting edge 18k and the backing edge 20k bound a cutting opening 22k for inserting a workpiece, in particular a sheet metal workpiece. The cutting device 12k comprises a tool interface 24k for attaching the shearing unit 14k to a tool holder 26k of a multifunction machine tool 10k. The cutting edge 18k and the backing edge 20k are disposed rigidly relative to each other. An angular bisector 28k of a cutting opening angle 30k of the cutting opening 22k is disposed in a plane perpendicular to an oscillation axis 34k of the tool interface 24k, at an angle 32k between 70° and 110° to a radial axis 60k of the tool interface 24k, which is perpendicular to the oscillation axis 34k and passes through an intersection point 36k of the cutting edge 18k and the backing edge 20k, and in a plane which is perpendicular to the oscillation axis 34k.

The blade 38k forms a further cutting edge 40k. The base body 16k forms a further backing edge 42k. The further cutting edge 40k and the further backing edge 42k bound a further cutting opening 44k. A further angular bisector 64k of the further cutting opening 44k is disposed in a plane perpendicular to the oscillation axis 34k of the tool interface 24k, at an angle 32k between 70° and 110° to the radial axis 60k of the tool interface 24k, which is perpendicular to the oscillation axis 34k and through the intersection point 36k of the cutting edge 18k and the backing edge 20k, and in a plane which is perpendicular to the oscillation axis 34k (FIG. 13).

The further cutting opening 44k has a further cutting opening angle. The further cutting opening angle is different from the cutting opening angle 30k of the cutting opening 22k. The further cutting opening 44k is disposed after the cutting opening 22k when viewed in a direction from the tool interface 24k towards the cutting opening 22k. The further cutting opening angle of the further cutting opening 44k is smaller than the cutting opening angle 30k of the cutting opening 22k. The cutting edge 18k is at a 79° angle to a main direction of extent of the base body 16k in a plane perpendicular to the oscillation axis 34k. The backing edge 20k is at a 47° angle to the main direction of extent of the base body 16k in a plane perpendicular to the oscillation axis 34k. The further cutting edge 40k is at a 66° angle to the main direction of extent of the base body 16k in a plane perpendicular to the oscillation axis 34k. The further backing edge 42k is perpendicular to the main direction of extent of the base body 16k in a plane perpendicular to the oscillation axis 34k (FIG. 13).

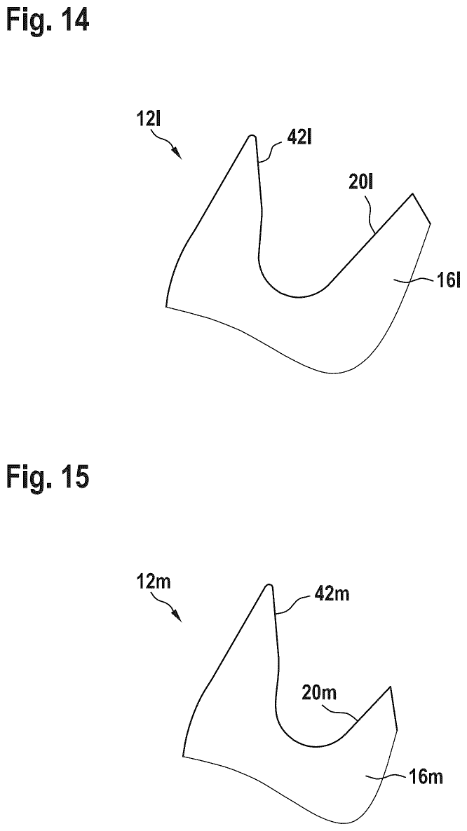

FIG. 14 shows a cutting device 12l. The cutting device 12l comprises a shearing unit 14l. The shearing unit 14l comprises a base body 16l, which comprises a cutting edge 18l and a backing edge 20l. The cutting edge 18l and the backing edge 20l bound a cutting opening 22l for inserting a workpiece, in particular a sheet metal workpiece. The cutting device 12l comprises a tool interface 24l for attaching the shearing unit 14l to a tool holder 26l of a multifunction machine tool 10l. The cutting edge 18l and the backing edge 20l are disposed rigidly relative to each other. An angular bisector 28l of a cutting opening angle 30l of the cutting opening 22l is disposed in a plane perpendicular to an oscillation axis 34l of the tool interface 24l, at an angle 32l between 70° and 110° to a radial axis 60l of the tool interface 24l, which is perpendicular to the oscillation axis 34l and passes through an intersection point 36l of the cutting edge 18l and the backing edge 20l, and in a plane which is perpendicular to the oscillation axis 34l.

The base body 16l comprises a further backing edge 42l. The further backing edge 42l comprises two regions which are integrally formed with each other. The two regions are formed angled to one another. The second region of the two regions, which is disposed after the first region of the two regions in a shearing direction of the cutting device 12l, is disposed at an angle to the first region (FIG. 14).

FIG. 15 shows a cutting device 12m. The cutting device 12m comprises a shearing unit 14m. The shearing unit 14m comprises a base body 16m, which comprises a cutting edge 18m and a backing edge 20m. The cutting edge 18m and the backing edge 20m bound a cutting opening 22m for inserting a workpiece, in particular a sheet metal workpiece. The cutting device 12m comprises a tool interface 24m for fastening the shearing unit 14m to a tool holder 26m of a multifunctional tool machine 10m. The cutting edge 18m and the backing edge 20m are disposed rigidly relative to each other. An angular bisector 28m of a cutting opening angle 30m of the cutting opening 22m is disposed in a plane perpendicular to an oscillation axis 34m of the tool interface 24m, at an angle of 32m between 70° and 110° to a radial axis 60m of the tool interface 24m, which is perpendicular to the oscillation axis 34m and passes through an intersection point 36m of the cutting edge 18m and the backing edge 20m, and in a plane which is perpendicular to the oscillation axis 34m.

The base body 16m comprises a further backing edge 42m. The further backing edge 42m comprises two regions, which are formed integrally with each other. The two regions are rounded relative to each other, having a radius. The second region of the two regions, which is disposed after the first region of the two regions in a shearing direction of the cutting device 12m, is disposed rounded relative to the first region (FIG. 15).

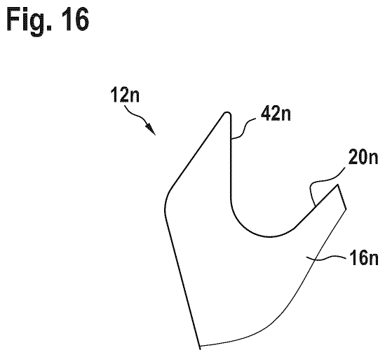

FIG. 16 shows a cutting device 12n. The cutting device 12n comprises a shearing unit 14n. The shearing unit 14n comprises a base body 16n, which comprises a cutting edge 18n and a backing edge 20n. The cutting edge 18n and the backing edge 20n bound a cutting opening 22n for inserting a workpiece, in particular a sheet metal workpiece. The cutting mechanism 12n comprises a tool interface 24n for attaching the shearing unit 14n to a tool holder 26n of a multifunction machine tool 10n. The cutting edge 18n and the backing edge 20n are disposed rigidly relative to each other. An angular bisector 28n of a cutting opening angle 30n of the cutting opening 22n is disposed in a plane perpendicular to an oscillation axis 34n of the tool interface 24n, at an angle 32n between 70° and 110° to a radial axis 60n of tool interface 24n, which is perpendicular to the oscillation axis 34n and passes through an intersection point 36n of the cutting edge 18n and the backing edge 20n, and in a plane which is perpendicular to the oscillation axis 34n. The base body 16n comprises a further backing edge 42n. The further backing edge 42n is formed by a straight edge of the base body 16n (FIG. 16).

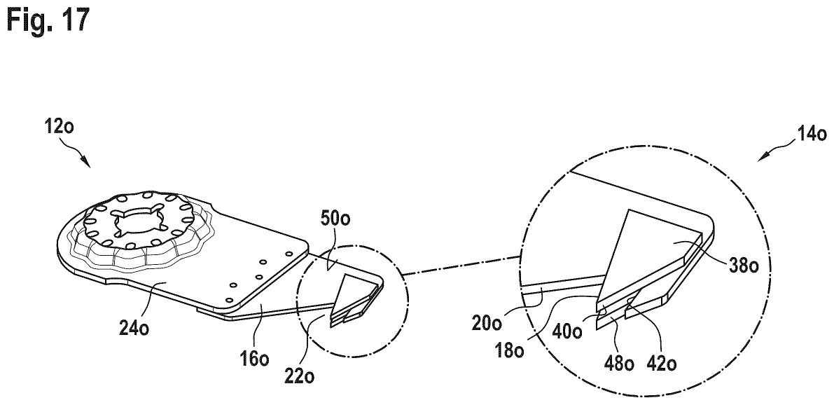

FIG. 17 shows a cutting device 12o. The cutting device 12o comprises a shearing unit 14o. The shearing unit 14o comprises a base body 16o, which comprises a cutting edge 18o and a backing edge 20o. The cutting edge 18o and the backing edge 20o bound a cutting opening 22o for loading a workpiece, in particular a sheet metal workpiece. The cutting device 12o comprises a tool interface 24o for attaching the shearing unit 14o to a tool holder 26o of a multifunction machine tool 10o. The cutting edge 18o and the backing edge 20o are disposed rigidly relative to each other. An angular bisector 28o of a cutting opening angle 30o of the cutting opening 22o is disposed in a plane perpendicular to an oscillation axis 34o of the tool interface 24o, at an angle 32o between 70° and 110° to a radial axis 60o of the tool interface 24o, which is perpendicular to the oscillation axis 34o and runs through an intersection point 36o of the cutting edge 18o and the backing edge 20o, and in a plane which is perpendicular to the oscillation axis 34o.

The shearing unit 14o comprises a further blade 48o, which is particularly identical to the blade 38o. The further blade 48o is disposed on a further lateral surface 52o of the base body 16o facing away from the lateral surface 50o. The blade 38o and the further blade 48o are disposed in a congruent manner perpendicular to a main extension plane of the base body 16o. The base body 16o, the blade 38o and the further blade 48o are connected to each other in a single piece (FIG. 17).

1. A cutting device for an oscillating multifunction machine tool, comprising:
at least one shearing unit comprising at least one base body, a cutting edge, and a backing edge, the cutting edge and the backing edge bounding a cutting opening configured for inserting a workpiece; and
a tool interface configured to attach the shearing unit to a tool holder of the multifunction machine tool, wherein:
the cutting edge and the backing edge are disposed rigidly relative to one another, and
an angular bisector of a cutting opening angle of the cutting opening is disposed in a plane perpendicular to an oscillation axis of the tool interface, at an angle between 70° and 110° to a radial axis of the tool interface, the radial axis being (i) perpendicular to the oscillation axis, (ii) passing through an intersection point of the cutting edge and the backing edge, and (iii) in a plane which is perpendicular to the oscillation axis.

2. The cutting device according to claim 1, wherein the shearing unit comprises at least one blade, which at least forms the cutting edge and is disposed on a lateral surface of the base body, which is substantially perpendicular to the oscillation axis.

3. The cutting device according to claim 2, wherein:
the blade further comprises at least one further cutting edge
the base body comprises at least one further backing edge,
the further cutting edge and the further backing edge bound a further cutting opening, and
a further angular bisector of the further cutting opening is disposed in a plane perpendicular to the oscillation axis of the tool interface at an angle between 70° and 110° to the radial axis of the tool interface.

4. The cutting device according to claim 2, wherein:
the shearing unit comprises at least one further blade disposed on a further lateral surface of the base body facing away from the lateral surface, and
the blade and the further blade are disposed congruent to each other when viewed perpendicular to a main extension plane of the base body.

5. The cutting device according to claim 1, wherein the base body comprises at least one chamfered edge, which is disposed on a side of the base body facing away from the blade and runs parallel to the backing edge.

6. The cutting device according to claim 1, wherein the blade comprises at least one chamfered edge, which is disposed on a side of the blade facing away from the base body and runs parallel to the cutting edge.

7. The cutting device according to claim 1, wherein the base body comprises at least one carbide insert, which forms at least the cutting edge and/or the backing edge.

8. The cutting device according to claim 1, wherein the tool interface and the base body of the shearing unit are integrally connected to one another.

9. The cutting device according to claim 1, wherein the base body, and the blade are integrally connected to each other.

10. A multifunction machine tool comprising:
the cutting device according to claim 1.

11. A method for manufacturing the cutting device according to claim 1.

12. The method according to claim 11, comprising:
producing the a shearing unit of the cutting device from a blank; and
shaping the shearing unit such that main extension planes of the blade and the base body of the shearing unit are disposed parallel to one another.

13. The method according to claim 12, further comprising:
producing the shearing unit via at least one material connection between the at least one blade and the base body of the shearing unit.

14. The cutting device according to claim 4, wherein the at least one further blade is identical to the blade.

15. The cutting device according to claim 3, wherein the base body comprises at least one chamfered edge, which is disposed on a side of the base body facing away from the blade and runs parallel to the backing edge and/or to the further backing edge.
